(19) United States
(12) Patent Application Publication
(10) Pub. No.: US 2010/0132882 A1
(43) Pub. Date: Jun. 3, 2010

(54) Device For Cutting Through The Adhesive Bead Of Panes Fixed By Bonding

(76) Inventors: Matthias Hess, Filderstadt (DE); Joachim Clabunde, Heubach (DE); Olaf Klabunde, Giengen (DE); Juergen Blickle, Goeppingen (DE)

Correspondence Address: ST. ONGE STEWARD JOHNSTON & REENS, LLC, 986 BEDFORD STREET, STAMFORD, CT, 06905-5619, US

(21) Appl. No.: 12/628,637

(22) Filed: Dec. 1, 2009

(30) Foreign Application Priority Data
Dec. 1, 2008 (DE) 10 2008 060 811.4
Dec. 1, 2008 (DE) 10 2008 060 812.2
Feb. 13, 2009 (DE) 10 2009 010 463.1

(51) Int. Cl. B32B 38/10

(52) U.S. Cl. 156/250; 156/510

(57) ABSTRACT

The invention provides a device and a method for cutting through an adhesive bead of a pane using a motor-driven winding-up device. The winding-up device includes a coil adapted to wind up a cutting wire for cutting through the adhesive bead and can be coupled, via a coupling that can be disengaged, to a suction disk that can be located on the vehicle inside in such a way that, preferably, the winding-up device is rotatably received on the suction disk. When the winding-up device is driven, it will therefore align itself automatically to the cutting wire.

### CROSS-REFERENCE TO RELATED APPLICATIONS

The present application claims priority of German patent application No. 10 2009 010 463.1 filed on Feb. 13, 2009, German patent application No. 10 2008 060 812.2 filed on Dec. 1, 2008 and German patent application No. 10 2008 060 811.4 filed on Dec. 1, 2008, the content of which is incorporated herein by reference.

### BACKGROUND OF THE INVENTION

The present invention relates to a device for cutting through an adhesive bead of a pane, having a motor-driven winding-up device that comprises a coil adapted to wind up a cutting means for cutting through the adhesive bead.

The invention further relates to a method for cutting through an adhesive bead of a pane wherein a cutting means is placed around the adhesive bead from the outside, a first end of the cutting means is fixed, a second end of the cutting means is passed through the adhesive bead and is fastened on the winding-up device, and the winding-up device is driven to wind up the cutting means for cutting through the adhesive bead.

A device and a method of the kind specified above are known from DE 10 2006 013 417 A1.

The device and the method are suited for cutting out panes installed, for example, in motor vehicles, buildings, railway trains, cableway cabins, aircraft and ships. Although the present application will predominantly refer to applications in connection with vehicles, those applications are described by way of example only and are not meant to restrict the application.

Windshields of modern vehicles are firmly connected with a circumferential body flange by an adhesive bead consisting of a polyurethane adhesive or another suitable adhesive. The adhesive bead consists of a material so strong that the adhesive, together with the windshield, increase the mechanical stability of the vehicle. It is understood that due to the high strength and toughness of the adhesive cutting through the adhesive is a relatively difficult task.

However, as windshields have to be exchanged relatively frequently, due to rock-fall or other damage, there must be available for every vehicle type a suitable device and/or a suitable method by which the windshield can be removed.

According to the known method, the winding-up device is supported on the frame or body flange by a support while the winding-up device is driven to progressively cut through the adhesive bead. During that process, the winding-up device and the support are moved along the frame or the adhesive bead in accordance with the progress of the cutting operation.

In this regard the complicated way in which the winding-up device has to be guided along the body flange has been found to be a disadvantage. In some cases, access to the body flange is obstructed by projecting parts. In addition, rather high forces have to be applied when guiding the winding-up device along the body flange. And there is further a risk that the body flange may be damaged by the winding-up device and the support being guided along the flange.

Further, DE 297 11 291 U1 describes a pane-separating device adapted to cut through an adhesive bead of a pane fixed by bonding, having a pair of suction disks that can be attached to the pane to be separated, wherein a winding-up device is connected with each of the suction disks via a linkage and wherein each linkage allows a movement to occur between the suction disks and the winding-up device about two axes that extend substantially in parallel to the pane surface and vertically one relative to the other.

Although in principle it is possible to cut out a pane using such a device, the way of fixing the pane-separating device by a pair of suction disks is very complex. In addition, the position of the device frequently has to be changed as the geometric conditions may be very disadvantageous.

### SUMMARY OF THE INVENTION

In view of this, it is a first object of the invention to disclose a device for cutting through the adhesive bead of a pane that makes the process of cutting through the adhesive bead of the pane a simple and easy task.

It is a second object of the invention to disclose a device for cutting through the adhesive bead of a pane that makes the process of cutting for the worker easy and little tiring.

It is a third object of the invention to disclose a device for cutting through the adhesive bead of a pane that avoids damage to the body to which the pane is attached.

Further, the invention is to disclose a method for cutting through the adhesive bead of a pane fixed by bonding which is as simple as possible and little tiring for the worker.

These and other objects of the invention are achieved by a device of the before-mentioned kind in that the winding-up device is detachably held on a suction disk, that can be located on the vehicle inside, via a coupling.

The object of the invention is thus perfectly achieved.

This is so because the device according to the invention provides an especially simple and energy-saving way of cutting through the adhesive bead because, being detachably mounted on the suction disk, it can be fixed on the suction disk in a simple way.

According to a preferred further development of the invention, the winding-up device is mounted to rotate on the suction disk.

This provides an especially comfortable way of cutting out a pane as the winding-up device will in this case automatically align itself to the cutting means during operation of the winding-up device so that the adhesive bead can be cut through easily.

The fact that the winding-up device is to be fixed on the pane via a single suction disk makes working with the device especially easy and energy-saving because there is no need to guide the winding-up device by hand; instead the device is fixed directly on the vehicle inside.

In the context of the present application the term “cutting means” is to be understood to mean every type of wire or cord basically suited for cutting through an adhesive bead of a vehicle pane. This means that a cutting means must have sufficient tear strength and flexibility, and must under certain circumstances be provided with a suitable coating or suitable surface features in the form of a toothing or the like to support the cutting operation. However, it is understood that the term “cutting means” also includes a suitable cord made from a plastic material or any other material.

According to another embodiment of the invention, the coupling comprises a coupling element in the form of a flange projecting from a pin radially to the outside, and a matching coupling counter-element in the form of a keyhole in which the coupling element can be received and can be displaced to an end position in which the coupling element is rotatably held on the counter-element of the coupling.

This makes it possible to fix the winding-up device on the suction disk from the vehicle inside in a rapid and simple way, using the detachable coupling. The end position may also be secured by a locking mechanism so as to prevent easy slipping-off of the coupling element.

According to another embodiment of the invention, the coupling is rotatably held on the suction disk or on a housing of the winding-up device.

In that case, rotation between the winding-up device and the suction disk is not to be ensured by the coupling as such, but is rendered possible by separate means. This results in a wide range of possible configurations of the coupling.

According to another embodiment of the invention, there is provided a mechanism that secures the coupling from getting detached during rotation.

While usually the coupling is secured from slipping off during rotation relative to the suction disk over a limited angle of 180°, for example, it is possible in this way to allow full rotation of the winding-up device over an angle of more than 180° or even up to 360°. This can be rendered possible by a locking means. Or the coupling may be adjusted for this purpose by giving the respective coupling elements a mated configuration.

According to another embodiment of the invention, a means for fixing one end of the cutting means is provided on the suction disk.

While the cutting means disclosed in connection with the method known from DE 10 2006 013 417 A1 is to be fixed on the wiper shaft, for example, from the outside, it is now possible to fix it directly on the suction disk. So, it is no longer necessary, for example, to fix the cutting means in a location of the body that is difficult to access. Instead, the suction disk anyway present may be used also for fixing the cutting means. It is, however, understood that a separate suction disk may be used for that purpose as well.

According to another embodiment of the invention, a clamping means is provided on the suction disk for fixing the cutting means.

This allows the cutting means to be fixed on the suction disk easily and quickly.

To this end, there may be provided on the suction disk a block having at least one opening, preferably a plurality of openings, for receiving one end of the cutting means and for fixing it by a clamping element, preferably by screwing.

For clamping the cutting means a screw may be used which when being screwed down fixes the end of the cutting means by its end face.

That way of fixing may also be combined with a configuration of the counter-element of the coupling as a pin with a flange that projects in radially outward direction. The flange or pin may in this case consist of a correspondingly shaped screw.

An alternative embodiment of the invention is provided with a quick-acting clamping mechanism, especially a Curry clamp, for fixing one end of the cutting element.

This likewise provides an easy and quick way of fixing the cutting means.

According to another embodiment of the invention, one guide roll, preferably at least two guide rolls, are provided for guiding the cutting means to the coil.

This feature provides the advantage that the cutting means is at any time optimally aligned relative to the cutting area of the cutting means on the adhesive bead, irrespective of the particular position of the winding-up device, so as to ensure well-ordered winding up on the coil.

If two guide rolls are provided, these preferably are seated on axes which define between them a plane that extends through the coil, substantially in parallel to a coil axis. Preferably, the cutting means is wound up on the coil substantially tangentially.

This guarantees that the cutting means will be wound up properly at any time.

According to an advantageous embodiment of the invention, two guide rolls are seated on axes in such a way that their axes define between them a plane that extends through the coil of the winding-up device substantially in parallel to one axis.

This has the effect that the cutting means will be supplied to the coil substantially vertically. Winding-up the cutting means is thereby facilitated.

Further, each guide roll preferably is provided with guide surfaces for guiding the cutting means to an opening of the coil housing, in a direction substantially tangential to the coil.

It is ensured in that way that the cutting means will be safely supplied to the coil from substantially any point on the curve described by the circumferential adhesive bead, which allows the device to be operated in a multidirectional way and the cutting angle to be positively influenced by changing the position of the device.

According to a further embodiment of the invention, a support is exchangeably fitted on the winding-up device.

In that case, the winding-up device can be detached from the suction disk for areas of the adhesive bead that would be impossible or difficult to cut out with the winding-up device fixed on the suction disk, due to unfavorable geometric conditions. Now, the winding-up device can be guided on the pane along its associated body flange, with the aid of the support, to allow the adhesive bead to be cut through in those areas.

Also, that embodiment may be used in cases where work is performed using the support and where the position of the winding-up device must be changed after an interruption of work. The coupling can then be used for hanging up the device temporarily until work is resumed at a different point.

It is understood that the mechanism for guiding the winding-up device along the vehicle body using the support may be combined in some cases with a drive for the winding-up device mounted rotatably on the suction disk.

The invention is further achieved by a method for cutting through the adhesive bead of a pane comprising the steps of:
Placing a cutting means around the adhesive bead from the outside;
fixing a first end of the cutting means;
fixing a motor-driven winding-up device rotatably on a suction disk on the vehicle inside using a coupling;
guiding a second end of the cutting means through the adhesive bead and fixing it on the winding-up device; and
driving the winding-up device for cutting through the adhesive bead, during which process the winding-up device aligns itself to the cutting means.

This allows the adhesive bead to be cut through in a simple and energy-saving way. Due to the fact that the winding-up device will align itself directly to the cutting means, relatively good cutting results are achieved, due to an advantageous alignment of the winding-up device.

According to an advantageous further development of that method, the first end of the cutting means is guided through the adhesive bead and is fixed on the pane.

Fixing can be effected in this case using that suction disk which also serves to take up the winding-up device.

This leads to an especially simple way of fixing the end of the cutting means so that the cutting means need no longer be fixed on the wiper shaft, for example, which may be an awkward operation.

The object of the invention is further achieved by a method for cutting through an adhesive bead of a pane comprising the steps of:
Placing a cutting means around the adhesive bead from the outside;
fixing a first suction disk on the pane from the inside;
guiding a first end of the cutting means through the adhesive bead and fixing it on the suction disk;
guiding a second end of the cutting means through the adhesive bead and fixing it on a motor-driven winding-up device;
driving the winding-up device to wind up the cutting means for cutting through the adhesive bead.

This method likewise provides an advantageous way of cutting though the adhesive bead on a pane. Regardless of whether the winding-up device is rotatably fixed on the pane using a suction disk, or is guided along the interior of the vehicle with the aid of a support, fixing the end of the cutting means is facilitated as the end of the cutting means is fixed directly on a suction disk. So, the cutting means no longer has to be fixed on another stationary body part, which might be a rather awkward operation.

It is understood that the features of the invention mentioned above and those yet to be explained below can be used not only in the respective combination indicated, but also in other combinations or in isolation, without leaving the scope of the invention.

### BRIEF DESCRIPTION OF THE DRAWINGS

Further features and advantages of the invention will become apparent from the description that follows of certain preferred embodiments, with reference to the drawing. In the drawing

FIG. 1 shows a pane with a motor-driven winding-up device for winding up a cutting means, which is rotatably held on a suction disk on the pane;

FIG. 2 shows a perspective view of the winding-up device according to FIG. 1, in an enlarged scale;

FIG. 3 shows a first embodiment of a suction disk with a coupling element intended to receive the winding-up device;

FIG. 4 shows a second embodiment of a suction disk with a coupling element intended to allow rotation of and to receive the winding-up device, and a clamping mechanism, arranged at a spacing, for taking up one end of the cutting means;

FIG. 5 shows another embodiment of a suction disk where a coupling element intended to receive the winding-up device is combined with a clamping mechanism intended to take up one end of the cutting means;

FIG. 6 shows a modification of the embodiment according to FIG. 5;

FIG. 7 shows an enlarged view of the clamping mechanism according to FIG. 6;

FIG. 8 shows an embodiment of the invention slightly modified relative to FIG. 1, where an end of the cutting means that is to be fixed on the vehicle is now held on a suction disk fixed on the pane, by a clamping mechanism; and

FIG. 9 shows a modification of the method illustrated in FIGS. 1 to 8, where the winding-up device for cutting through the adhesive bead is guided along the body flange using a support.

### DETAILED DESCRIPTION OF PREFERRED EMBODIMENTS

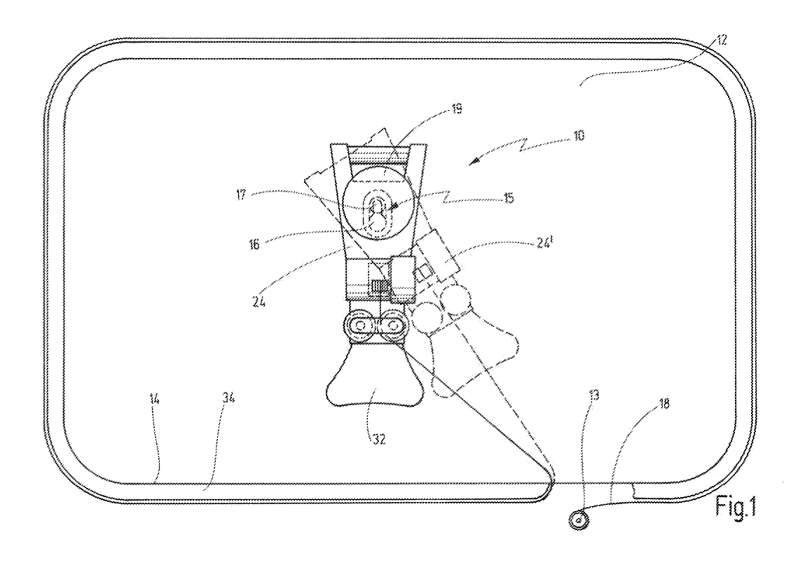

In FIG. 1, the device according to the invention is indicated generally be reference numeral 10.

The device 10 comprises a winding-up device adapted to wind up a cutting means 18 that serves to cut through an adhesive bead 34 of a pane 12.

The pane 12 may, for example, be a windshield of a motor vehicle which is bonded onto a body flange 14 using an adhesive bead 34 that consists of a very tough plastic material, such as a polyurethane adhesive. The adhesive bead 34 is extremely strong thereby contributing to the inherent stability of the vehicle.

When an adhesive bead 34 of that kind is to be cut through using a cutting means in the form of a wire or the like, then obviously considerable forces are required for that operation.

While the prior art normally used hand-held winding-up devices for that operation, the invention now proposes a motor-driven winding-up device 24 that can be rotatably fixed on the pane 12 with the aid of a suitable coupling 15 on a suction disk 19.

For cutting through the adhesive bead, the cutting means 18 is at first placed around the pane 12 from the outside, and a first end of the cutting means is fixed on a stationary part of the vehicle, for example on the wiper shaft 13. Then a second end is guided through the adhesive bead and is fixed on the winding-up device 24. The winding-up device 24 is rotatably fixed on the suction disk 19 via a suitable coupling 15, in a manner that will be described in more detail hereafter. This is effected using a coupling element 16 and a coupling counter-element 17 that provide a detachable connection and at the same time allow the winding-up device 24 to rotate relative to the suction disk 19.

When the winding-up device 24 is operated, it rotates from its original position, illustrated in full lines in FIG. 1, to the position illustrated by broken lines, indicated by 24′. Now, the adhesive bead 34 can be progressively cut out by winding up the cutting means 18, during which process the winding-up device 24 will always align itself automatically to the cutting means 18.

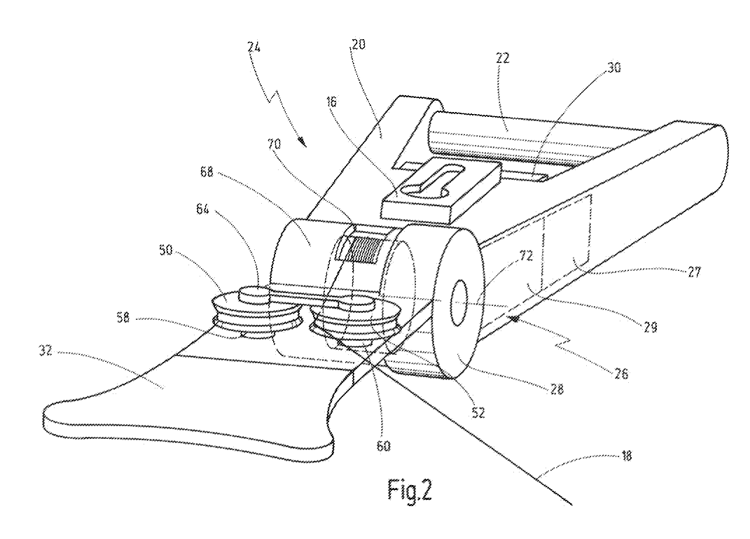

The structure of the winding-up device 24 will now be described in more detail with reference to FIG. 2.

The winding-up device 24 comprises a housing 20 with a handle 22 provided on its one end. The housing 20 tapers like a wedge from the handle 22 toward the opposite end on which a support 32 is mounted in a detachable way. A coil 28, adapted to rotate about a coil axis 72, serves to wind up the cutting means 18. The coil 28 is protected from contact by an outer enclosure provided with a single opening 70 for carrying the cutting means 18 to the outside. In order to guarantee effective tangential winding-up of the cutting means 18 on the coil, two guide rolls 50, 52 are received one beside the other on stationary axes 58, 60 that allows the cutting means 18 to pass to the outside through the opening 70. In order to prevent the cutting means 18 from jumping out of the gap between the two guide rolls 50, 52, the two coil axes 58, 60 are connected one with the other by a cover element 64.

The two axes 58, 60 on which the guide rolls 50, 52 are seated define between them a plane parallel to the coil axis 72. Such an arrangement of the guide rolls 50, 52 relative to the coil 28 guarantees largely tangential winding-up of the cutting means 18 on the coil 28, regardless of the arrangement of the coil 28 as such. As is illustrated in FIG. 2, the coil 28 may have its coil axis 72 arranged substantially in parallel to the cover element 64 and parallel to the handle 22 provided on the outside.

However, an arrangement of the coil 28 turned by 90°, for example, would likewise be imaginable.

The winding-up device 24 can be motor-driven by a drive 26. The drive 26 comprises an electric motor 27 which drives a gearing 29 that is finally coupled with the coil 28.

In the illustrated case, an accumulator indicated by 30 serves as current supply to the electric motor 27. It is, however, understood that instead a mains-operated device may be used as well and that other types of drives, for example a compressed-air motor, could likewise be employed.

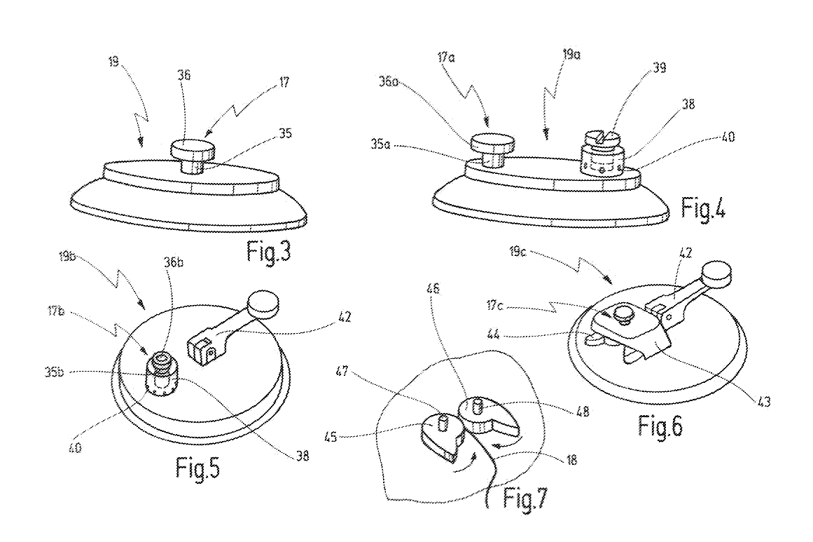

The upper surface of the housing 20 is further provided with a coupling element 16 in the form of a keyhole into which a corresponding coupling counter-element (FIGS. 3 to 6) can be introduced and in which it can be displaced to locate it in an end position.

The associated coupling counter-element, generally indicated by 17, is illustrated in FIG. 3. The coupling counter-element 17 comprises a pin 35 with a flange 36 projecting from its end in radially outward direction. The flange 36 can be introduced into the associated wide area of the keyhole coupling element 16 and can then be displaced along the narrower area of the coupling element until an end position is reached. Locking in that end position can be ensured by giving the coupling element 16 a special configuration, for example by providing two small cams or a suitable spring element. In that end position, the coupling counter-element 17 is rotatably held on the coupling element 16. A particular configuration of the keyhole shape allows rotation of the element by at least 180°. If rotation by more than 180° is desired, this can be achieved by a different form of the coupling element 16 or by an additional securing mechanism (such as the before-mentioned locking means).

Hereafter, different embodiments of the suction disk 19 will be described in more detail with reference to FIGS. 3 to 7.

In the illustration of FIGS. 3 and 4, a clamping lever that serves to attach the suction disk 19 by suction has been omitted for the sake of simplicity.

FIG. 4 shows a modification of the suction disk 19 according to FIG. 3, indicated generally by reference numeral 19a. In that case, means for clamping and fixing one end of the coupling element 18 are provided in addition to the coupling counter-element 17a, the design of which corresponds in full to the coupling counter-element 17 of FIG. 3. For this purpose a block 38, comprising a plurality of radial bores 40, is fixed on the upper surface of the suction disk 19a. The radial bores 40 allow one end of the cutting means 18 to be introduced. For locating the cutting means, there is provided a clamping screw 39 which is rotatably received in an associated threaded bore of the block 38 and which is capable of fixing by its end face an end that has been introduced into the bore 40.

FIG. 5 shows another modification of the suction disk 19a, indicated generally by reference numeral 19b. In that case, the counter-element of the coupling on the one hand and a clamping element intended to fix one end of the cutting means 18 on the other hand have been combined to a single unit. To this end, a block 38 received on the upper surface of the suction disk 18b is again provided, on its lower end, with a plurality of radial bores 40 designed to receive one end of the cutting means 18. A screw 36b that can be screwed into the block 38 has its head configured as a flange 36 or 36a, respectively, so as to serve as a counter-element to the coupling element 16. As to its form and size, the shaft of the screw 36b, indicated by 35b in FIG. 5, corresponds to the pin 35 of FIG. 3. The lower end of the screw 36b is provided with a suitable thread that can be screwed into a matching threaded blind hole in the block 38 for fixing by its end face one end of the cutting means 18 that has been introduced into the hole, and for simultaneously ensuring its location on the block 38. In combination with the block 38, this arrangement constitutes a counter-element 17 of the coupling.

In addition, a clamping lever 42, serving to operate the suction disk 19b, is illustrated in FIG. 5.

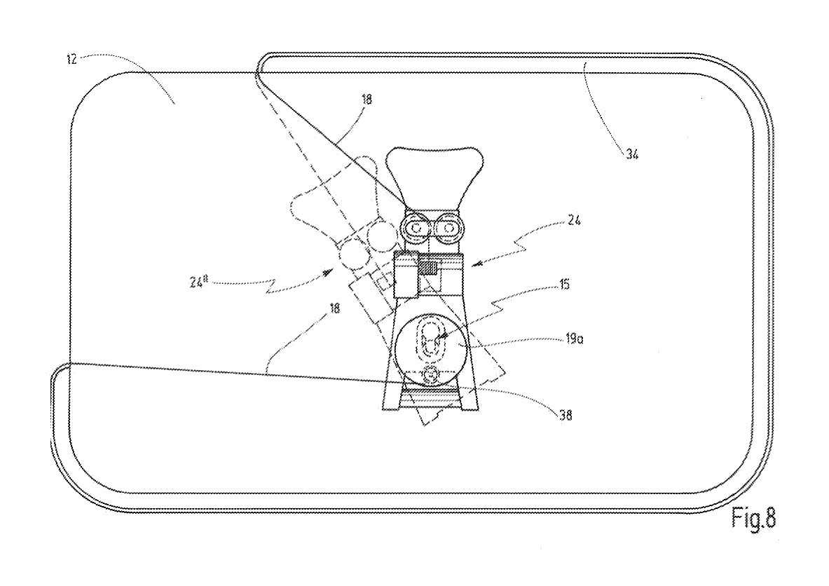

A further modification of the suction disk is illustrated in FIGS. 6 and 7 and is indicated generally by 19c. In that case, the functions of the counter-element 17c of the coupling on the one hand and of a clamping means 44, intended for fixing one end of the coupling means 18, on the other hand are decoupled one from the other.

As is shown in FIG. 7, the clamping means 44 is designed in this case as a quick-acting clamping mechanism, also known as “Curry clamp”. The quick-acting clamping mechanism 44 comprises two clamps 45, 46, which can be moved one relative to the other and can be pivoted about associated axes 47, 48 and which are spring-loaded in a suitable way. When the ends of the two clamps 45, 46 are moved in a direction indicated by the arrows the cutting means 18 can be pulled out of the space between the two clamps 45, 46. In contrast, in the released condition, an end of the cutting means 18 introduced into the space between the two clamps 45, 46 is permanently held between the two clamps 45, 46. According to FIG. 6, a substantially U-shaped bracket 43 extending above the quick-acting clamping mechanism 44 forms on its upside a base suited to receive a coupling counter-element 17c of the kind known from FIG. 3. Accordingly, one end of the cutting means 18 can be clamped and located on the quick-acting clamping mechanism 44, whose ends project outwardly from the opening formed by the bracket 43, while the counter-element 17c of the coupling, disposed on the upside of the bracket 43, serves to realize the connection with the coupling element 16.

FIG. 8 illustrates an application of the winding-up device 24 for cutting through the adhesive bead 34 where, contrary to the illustration of FIG. 1, one end of the cutting means 18 is fixed directly on the suction disk 19a by a suitable clamping mechanism on the block 38. In order to allow the end of the cutting means 18 to be fixed on the suction disk 19a, the end is pierced through the adhesive bead 34 and is then fixed by the clamping mechanism directly on the suction disk 19a. FIG. 8 shows the operation of cutting through the adhesive bead 34, where the winding-up device 24, starting from an inactive position 24 at the beginning of the winding-up operation, aligns itself directly to the cutting means 18, turning into the position 24″ indicated by broken lines. In the illustration of FIG. 8, part of the adhesive bead 34 has already been cut through.

Such an application of the winding-up device 24, with rotatable connection to the coupling 15, will be useful in particular when the pane 12 to be cut out does not present any particular obstacles to the cutting means 18. Such a pane could, for example, be a rear vehicle window or a pane of a rail vehicle where no particular obstacles are found.

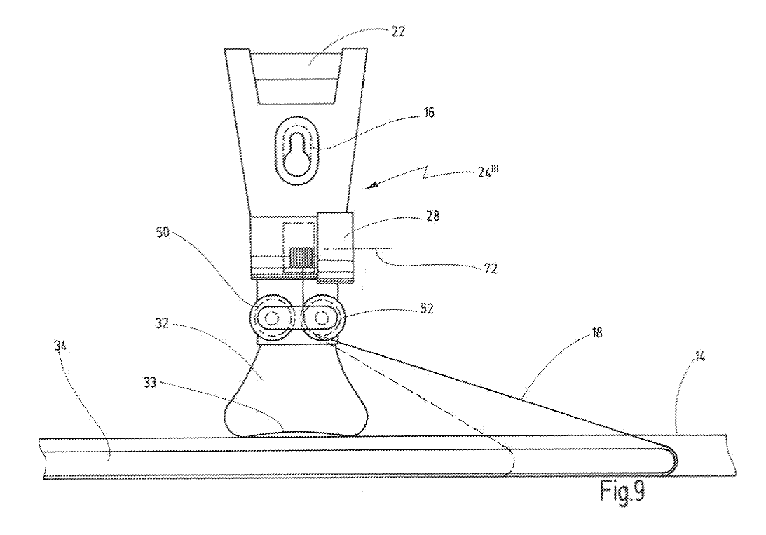

However, when the geometric conditions of a pane are such that the before-mentioned rotatable connection with the suction disk 19 on the pane 12 using the coupling 15 can be realized either not at all or only in part there is also the possibility to guide the winding-up device according to FIG. 9 along the body flange or the frame 14 or along the adhesive bead 34, using a support 32 provided on the end of the winding-up device opposite the handle 22.

The device is in this case supported on the surface of the body flange 14 by the end face 33 of the support 32, which permits the device to be guided in a direction parallel to the coil axis 72. The body flange 14 is progressively cut through in this case, starting out from the position of the cutting means 18 illustrated in full lines, which fact is illustrated in the drawing by the position of the cutting means 18 indicated by broken lines.

What is claimed is:

1. A device for cutting through an adhesive bead of a pane, comprising:
a motor-driven winding-up device having a coil for winding up a cutter for cutting through the adhesive bead;
a suction disk configured for attaching to an inside of the pane;
a coupling element attached to said winding-up device;
a coupling counter-element attached to said suction disk and being matched to said coupling element, configured for securing said coupling counter-element detachably and rotatably on said coupling element; and
at least one guide roll arranged for guiding said cutter when winding onto said coil;
a clamping means attached to said suction disk for securing one end of said cutter; and
a support configured for guiding said winding-up device along a body to which said pane is fixed.

2. A device for cutting through an adhesive bead of a pane, comprising:
a motor-driven winding-up device having a coil for winding up a cutter for cutting through the adhesive bead;
a suction disk configured for attaching to an inside of the pane;
a coupling comprising a coupling element and a coupling counter-element matched to each other, one of which being attached to said winding-up device, the other one of which being attached to said suction disk;
wherein said coupling is configured for securing said coupling counter-element detachably on said coupling element.

3. The device of claim 2, wherein said coupling is configured for allowing rotation of said coupling element relative to said coupling counter-element while being in a position secured to each other.

4. The device of claim 2, wherein said coupling counter-element is configured in a shape of a flange projecting from a pin radially outwardly; and
wherein said coupling element is configured in the shape of a keyhole, thereby allowing to receive said coupling counter-element in a first position and to displace said coupling counter-element into an end position in which said coupling counter-element is rotatably secured on said coupling element.

5. The device of claim 2, further comprising a locking means for securing said coupling counter-element against disengagement from said coupling element during rotation.

6. The device of claim 2, further comprising a clamping means attached to said suction disk for securing one end of said cutter.

7. The device of claim 6, further comprising a quick-acting clamping mechanism provided on said suction disk for securing said cutter.

8. The device of claim 2, further comprising a block attached to said suction disk and having at least one opening configured for receiving one end of said cutter and for securing said end by clamping.

9. The device of claim 2, further comprising at least one guide roll arranged for guiding said cutter when winding onto said coil.

10. The device of claim 1, comprising two guide rolls arranged for guiding said cutter when winding onto said coil, said guide rolls being seated on axes defining a plane therebetween, said plane extending through said coil substantially in parallel to an axis of rotation of said coil.

11. The device of claim 1, wherein said coil is held rotatably within a coil housing having an opening allowing to wind said cutter onto said coil, and wherein each guide roll comprises guiding surfaces arranged for guiding said cutter through said opening substantially tangentially onto said coil.

12. The device of claim 2, wherein winding-up device further comprises a support configured for guiding said winding-up device along a body to which said pane is fixed.

13. The device of claim 12, wherein said support is secured to said winding-up device exchangeably.

14. The device of claim 1, further comprising a block attached to said suction disk and having at least one opening configured for receiving one end of said cutter and for securing said end by clamping.

15. The device of claim 1, further comprising a quick-acting clamping mechanism provided on said suction disk for securing said cutter.

16. The device of claim 1, wherein said support is secured to said winding-up device exchangeably.

17. The device of claim 1, further comprising a locking means for securing said coupling counter-element against disengagement from said coupling element during rotation.

18. The device of claim 1, wherein said coupling counter-element is configured in a shape of a flange projecting from a pin radially outwardly; and
wherein said coupling element is configured in the shape of a keyhole, thereby allowing to receive said coupling counter-element in a first position and to displace said coupling counter-element into an end position in which said coupling counter-element is rotatably secured on said coupling element.

19. A method of cutting through the adhesive bead of a pane comprising the steps of:
placing a cutting means around the adhesive bead from the outside;
fixing a first end of the cutting means;
fixing a motor-driven winding-up device rotatably on a suction disk on the vehicle inside, using a coupling;
guiding a second end of the cutting means through the adhesive bead and fixing it on the winding-up device; and
driving the winding-up device for cutting through the adhesive bead, during which process the winding-up device aligns itself to the cutting means.

20. The method of claim 19, wherein the first end of the cutting means is guided through the adhesive bead and is fixed on the suction disk.
